(19) United States
(12) Patent Application Publication
(10) Pub. No.: US 2025/0145368 A1
(43) Pub. Date: May 8, 2025

(54) ATTACHABLE TRASH RECEPTACLE

(71) Applicant: Tiss Trash LLC, Twinsburg, OH (US)

(72) Inventors: Karen CAVADAS, Twinsburg, OH (US); Ashley CAVADAS, Twinsburg, OH (US)

(73) Assignee: Tiss Trash LLC, Twinsburg, OH (US)

(21) Appl. No.: 18/936,160

(22) Filed: Nov. 4, 2024

Related U.S. Application Data
(60) Provisional application No. 63/597,068, filed on Nov. 8, 2023.

(51) Int. Cl. B65F 1/14; A47K 10/42; B65D 21/08; B65D 83/08

(52) U.S. Cl. CPC B65F 1/14; A47K 10/421; B65D 21/086; B65D 83/0888; B65F 2240/164; B65F 2250/108; B65F 2250/114

(57) ABSTRACT

An attachable trash receptacle for supporting a container includes a depositing wall connected to one or more additional walls. The depositing wall and the one or more additional walls have interior surfaces and exterior surfaces. The interior surfaces define a receptacle for receiving an object. The depositing wall includes an edge defining a depositing opening contiguous with the receptacle. The interior surfaces include a ridge configured to support at least a portion of the container.

### FIELD OF INVENTION

The present application relates to attachable trash receptacles, more specifically to trash receptacles attachable to tissue boxes.

### BACKGROUND OF THE INVENTION

Conventional use of a tissue box involves removal of a tissue from the tissue box and then disposal of the used tissue into a separate trash receptacle. The relocation of the used tissue away from the tissue box can often be inconvenient, time consuming, and potentially difficult for a person feeling ill or with mobility challenges.

Accordingly, there is a need in the art for a trash receptacle that can be attached to a tissue box, particularly in a removable manner, such that tissues can be conveniently disposed of without requiring a separate trash receptacle.

### SUMMARY OF THE INVENTION

The present application relates to an enhanced trash receptacle assembly that allows for convenient disposal of tissues or other objects without requiring a separate trash receptacle. An attachable trash receptacle for supporting a container includes a depositing wall connected to one or more additional walls. The depositing wall and the one or more additional walls have interior surfaces and exterior surfaces. The interior surfaces define a receptacle for receiving an object. The depositing wall includes an edge defining a depositing opening contiguous with the receptacle. The interior surfaces include a ridge configured to support at least a portion of the container.

An attachable trash receptacle for supporting a container includes: a depositing wall connected to one or more additional walls; wherein the depositing wall and the one or more additional walls have interior surfaces and exterior surfaces; wherein the interior surfaces define a receptacle for receiving an object; wherein the depositing wall comprises an edge defining a depositing opening contiguous with the receptacle; and wherein the interior surfaces comprise a ridge configured to support at least a portion of the container.

The container may be a tissue box.

The tissue box may be of a standard size and shape.

The attachable trash receptacle may include one or more of cardboard or plastic.

The attachable trash receptacle may be at least partially additively manufactured or 3D-printed.

The attachable trash receptacle may be unitary with the container.

The depositing opening may be completely surrounded by the edge.

The depositing opening may be partially surrounded by the edge.

The container may be of a standard size and shape.

The attachable trash receptacle may further include hinges configured to collapse the attachable trash receptacle into a flattened state.

At least one or more of the dispensing wall or the depositing wall may be foldable.

The attachable trash receptacle may further include a bottom wall connected to the depositing wall and the additional side walls.

The bottom wall may include traction features on a bottom wall outer side.

A tissue box receptacle unit includes: a depositing wall connected to one or more additional walls; and a dispensing wall configured to be connected to the one or more additional walls; wherein the depositing wall, the dispensing wall, and the one or more additional walls have interior surfaces and exterior surfaces; wherein the interior surfaces define a receptacle for receiving an object and a dispensing chamber for dispensing the object; wherein the depositing wall comprises a depositing edge defining a depositing opening contiguous with the receptacle; wherein the interior surfaces comprise a ridge configured to support a container; and wherein the dispensing wall comprises a dispensing edge defining a dispensing opening contiguous with the dispensing chamber.

The dispensing wall may be detachable.

The tissue box receptacle unit may further include one or more hinges configured to collapse the tissue box receptacle unit into a flattened state.

At least one of the depositing wall, the additional walls, or the dispensing wall may be foldable.

The dispensing wall may be removably attached to the additional side walls and the depositing wall.

The tissue box receptacle unit may further include a bottom wall connected to the depositing wall and the one or more additional side walls.

The bottom wall may include a traction feature on a bottom wall bottom side.

### BRIEF DESCRIPTION OF THE DRAWINGS

FIGS. 1A-1H illustrate an attachable trash receptacle according to an exemplary embodiment.

FIGS. 2A-2H illustrate an attachable trash receptacle according to another exemplary embodiment.

FIGS. 3A-3F illustrate an attachable trash receptacle according to another embodiment.

FIGS. 4A-4F illustrate an attachable trash receptacle according to another exemplary embodiment.

FIG. 5 illustrates the use of an attachable trash receptacle according to a an exemplary embodiment.

FIG. 6 illustrates another use of an attachable trash receptacle according to an exemplary embodiment.

FIG. 7 further illustrates the use of the attachable trash receptacles of FIGS. 5 and 6.

FIG. 8 further illustrates use of the attachable trash receptacle of FIG. 5.

FIGS. 9A-9C illustrate an attachable trash receptacle according to another exemplary embodiment.

FIG. 10 illustrates an attachable trash receptacle according to another exemplary embodiment.

FIG. 11 illustrates an attachable trash receptacle according to another exemplary embodiment.

FIG. 12 illustrates an attachable trash receptacle according to another exemplary embodiment.

FIG. 13 illustrates an attachable trash receptacle according to another exemplary embodiment.

FIG. 14 illustrates an attachable trash receptacle according to another exemplary embodiment.

FIG. 15 further illustrates the attachable trash receptacle of FIG. 14.

FIG. 16 illustrates a trash receptacle according to another exemplary embodiment.

FIG. 17 illustrates a trash receptacle according to another exemplary embodiment.

FIG. 18 further illustrates the attachable trash receptacle of FIG. 17.

FIG. 19 illustrates an attachable trash receptacle according to another exemplary embodiment.

FIG. 20 illustrates an attachable trash receptacle according to another exemplary embodiment.

FIG. 21 illustrates an attachable trash receptacle according to another exemplary embodiment.

### DETAILED DESCRIPTION

Embodiments of the present application will now be described with reference to the drawings, wherein like reference numerals are used to refer to like elements throughout. It will be understood that the figures are not necessarily to scale.

Embodiments of the present application include attachable trash receptacles (or “trash receptacles”) that can be connected to a box. Embodiments also include tissue box receptacle units that can be either connected to a box or filled with tissues. The trash receptacle may be integrated with the tissue box as a single unit or removably attached to the tissue box.

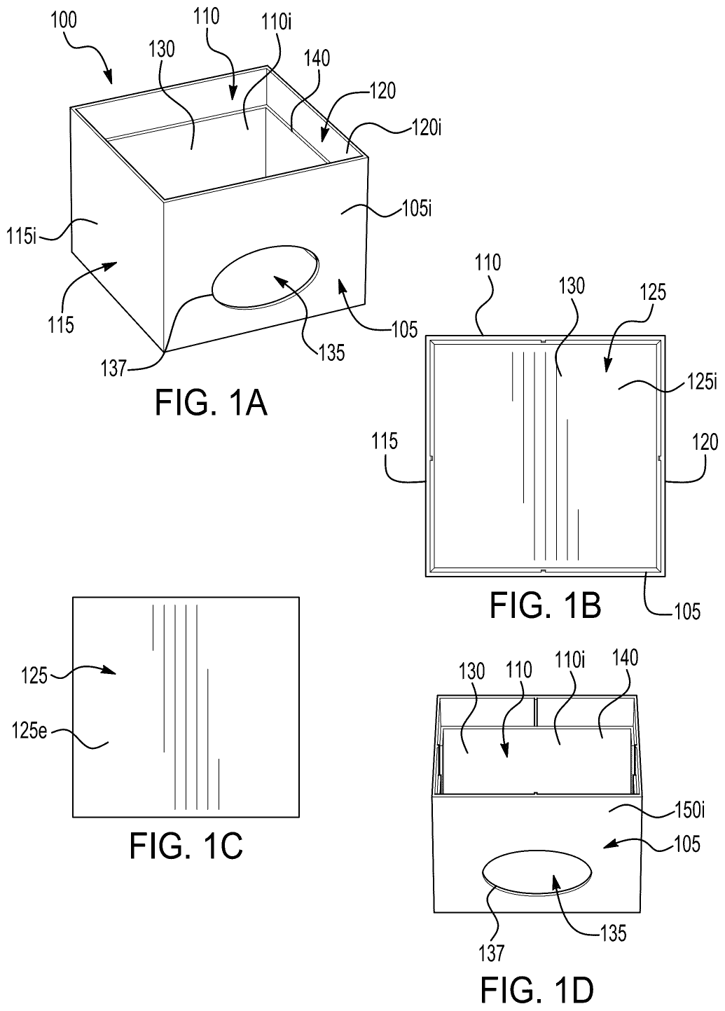

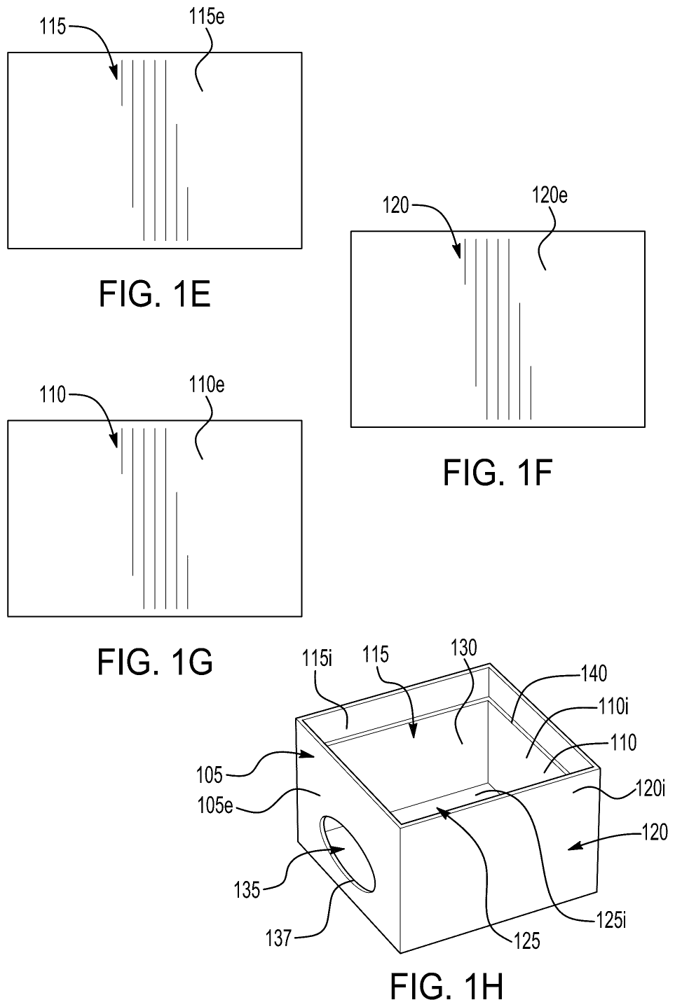

Turning first to FIGS. 1A-1H, an attachable trash receptacle (or “trash receptacle”) 100 is shown. The trash receptacle 100 includes a depositing wall 105, a back wall 110, side walls (or “sides”) 115, 120, and a bottom wall 125. The walls 105, 110, 115, 120, and 125 each have interior surfaces 105i, 110i, 115i, 120i, and 125i and exterior surfaces 105e, 110e, 115e, 120e, and 125e. The interior surfaces 105i, 110i, 115i, 120i, and 125i define a receptacle portion 130 in which objects, such as tissues or other trash, can be received. The depositing wall 105 includes a depositing opening 135 contiguous with the receptacle portion 130 through which trash or other objects can be deposited into the receptacle portion 130. The interior surfaces 105i, 110i, 115i, 120i, and 125i may include a ridge 140 upon which a box or container, such as a tissue box, may be placed, allowing the tissue box or container to rest above the receptacle portion 130 while leaving room in the receptacle beneath the tissue box. The depositing opening 135 allows trash to be deposited into the receptacle portion 130 of the trash receptacle 100 without having to remove the tissue box from atop the ridge 140. The depositing opening 135 can be defined by an edge 137 of the depositing wall 105, or by an edge 137 of any other wall 110, 115, 120, or 125. The trash receptacle 100 may be made of plastic, rubber, cardboard, wood, composite, metal, or any other suitable material. Alternatively or additionally, the attachable trash receptacle 100 may be made of a biodegradable and/or recyclable material.

A tissue box that had been attached to the receptacle may be removed from the ridge 140 so that the receptacle portion 130 may be emptied, and the same box or a different box may be placed upon the ridge 140. For example, a box of tissues may be placed on the ridge 140 of the trash receptacle 100, the tissues in the box may be used and then disposed of through the depositing opening 135 into the receptacle portion 130, and this process may be repeated until all or some of the tissues are removed from the box and disposed of into the receptacle portion 130. Alternatively or additionally, other waste can be disposed of in the receptacle portion 130, such as unwanted wrappers and receipts. The receptacle portion 130 may then be emptied, and a new replacement tissue box may be placed on top of the ridge 140.

What follows now are different embodiments and applications of a variety of attachable trash receptacles. Common details and features may be omitted in some of the following embodiments, and it should be understood that features from various of the embodiments may be combined where appropriate in a single device.

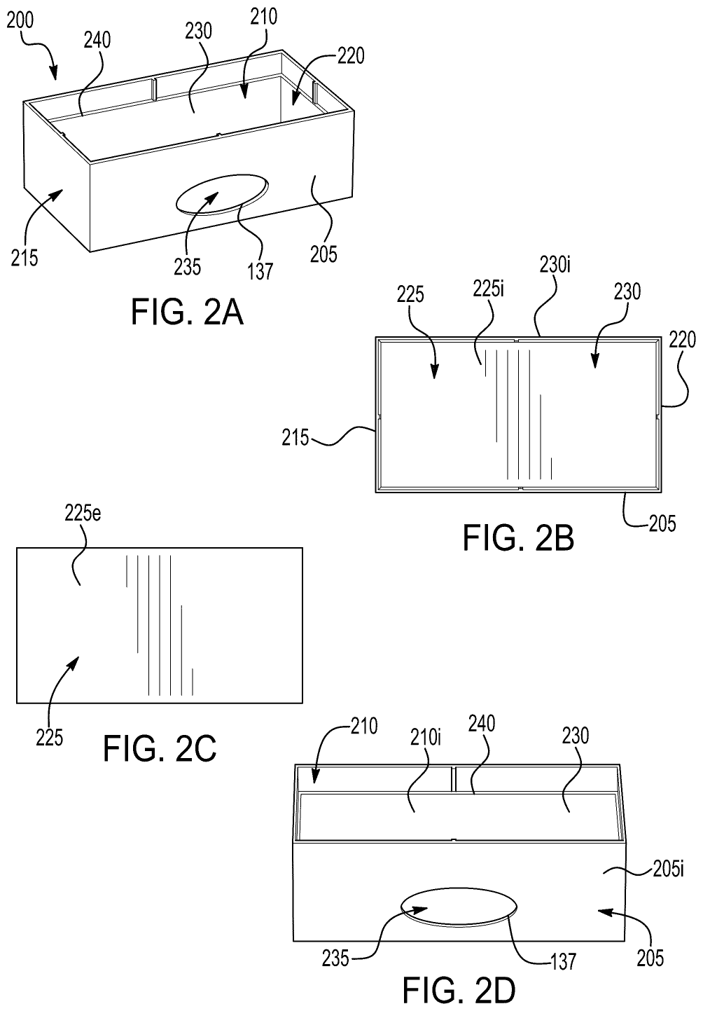

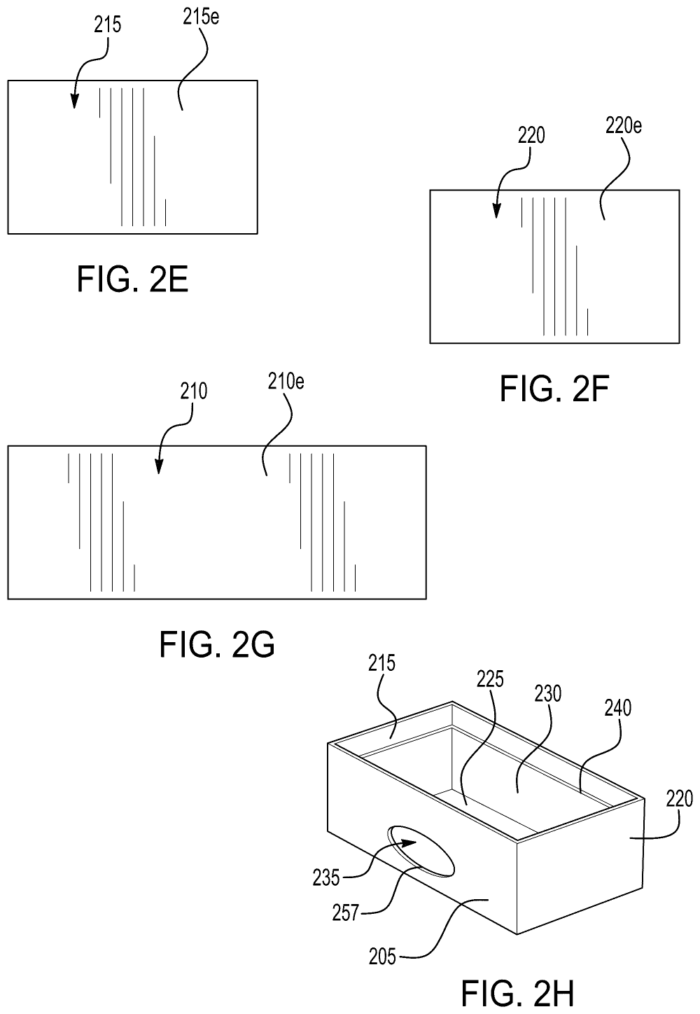

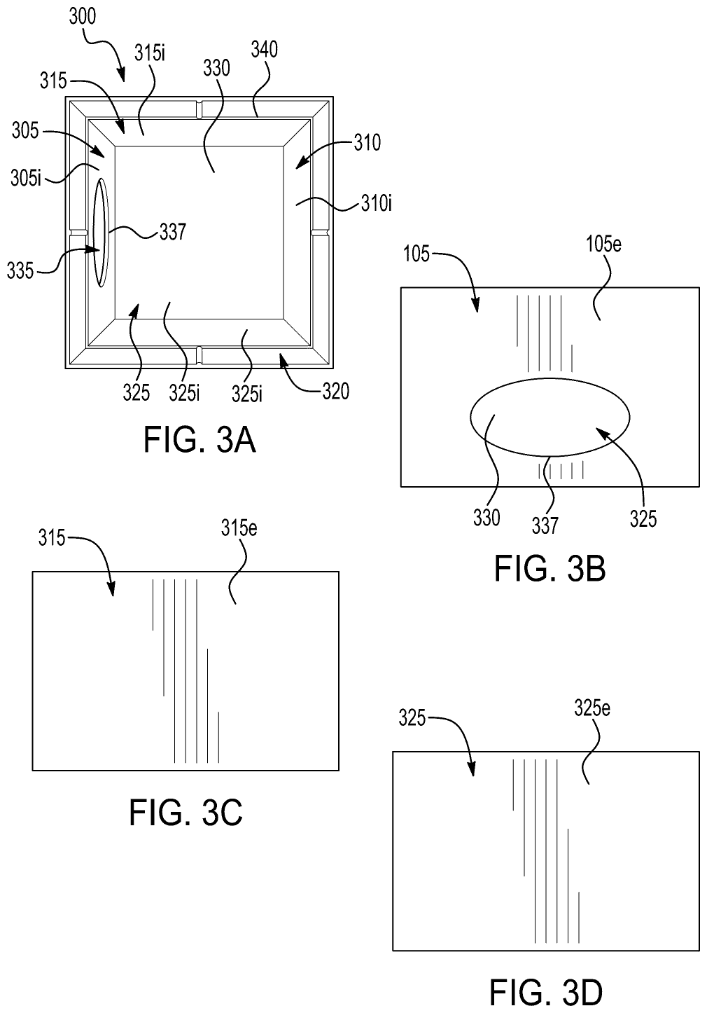

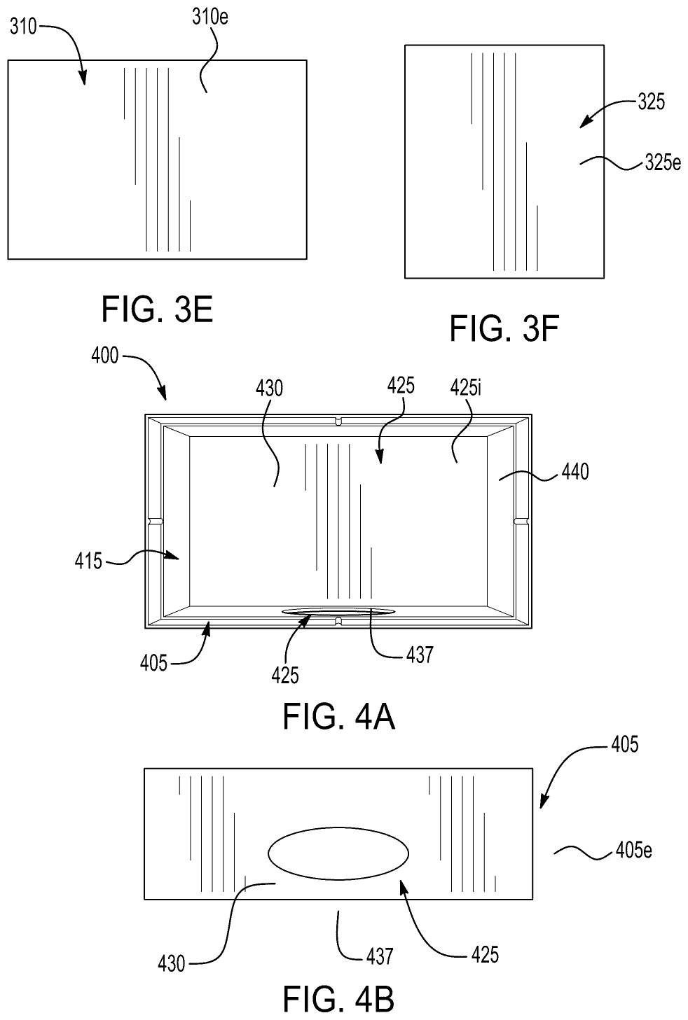

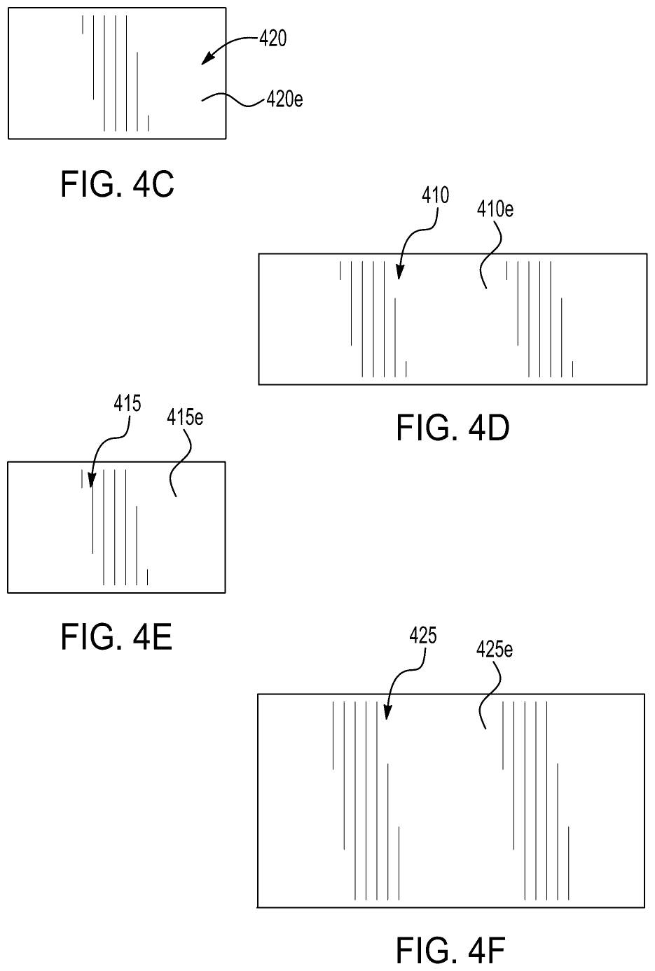

The attachable trash receptacles 200-1800 are substantially comparable to the above-referenced trash receptacle 100, and consequently the same reference numerals but indexed by 200-1800, are used to denote structures corresponding to similar structures in the attachable trash receptacles 200-1800, respectively. In addition, the foregoing description of the trash receptacle 100 is equally applicable to the attachable trash receptacles 200-1800. Moreover, aspects of the attachable trash receptacles 100-1800 may be substituted for one another or used in conjunction with one another where applicable. Initially, FIGS. 2A-2H, FIGS. 3A-3F, and FIGS. 4A-4F are variations on the embodiment of FIGS. 1A-1H showing different sizes and dimensions of the components that form the basic structure.

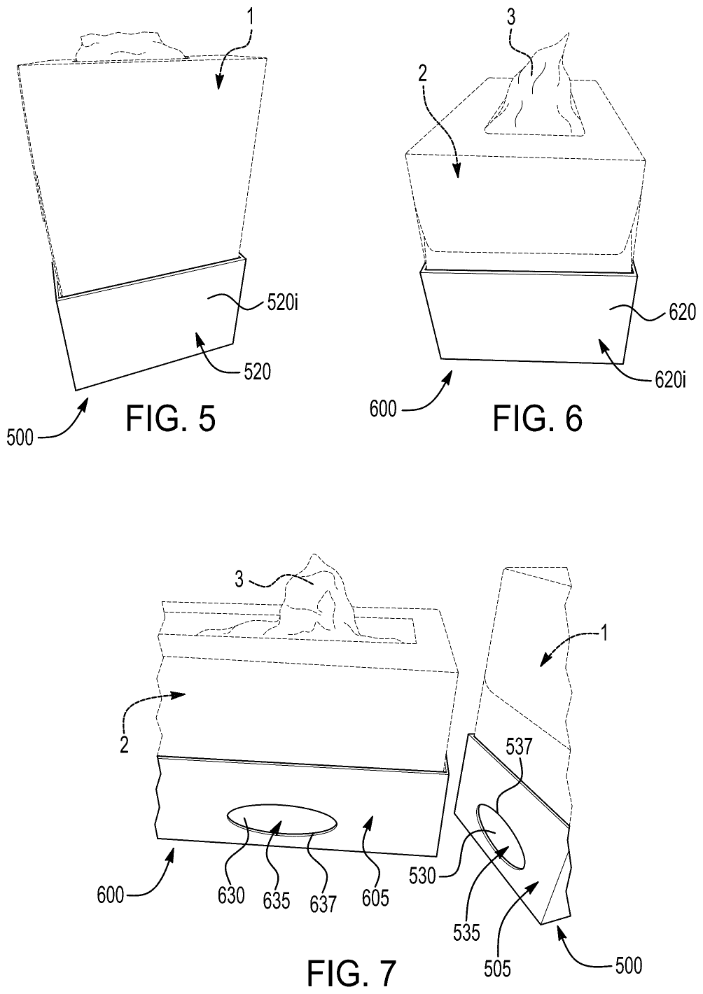

Turning next to FIGS. 5-7, trash receptacles 500 and 600 supporting tissue boxes 1 and 2 are shown. FIG. 5 shows a use of a trash receptacle 500 according to an embodiment. A standard tissue box 1 is placed atop the attachable trash receptacle 500. The tissue box 1 is upheld above the receptacle portion 530 by a ridge 540 on the interior surfaces 505i, 510i, 515i, 520i, and 525i of the attachable trash receptacle 500. Because the attachable trash receptacle 500 can be configured to rest conveniently below the tissue box 1, the combination of the attachable trash receptacle 500 and the tissue box 1 inhabits a relatively low area of resting surface such as a tabletop, countertop, ridge, etc., allowing free space to be maintained on the resting surface. As shown in FIG. 5, the attachable trash receptacle 500 can be configured to support a standard size tissue box 1 or a box with any other dimensions as may be suitable for any particular purpose. In FIG. 5, the tissue box 1 is of a standard “cubed” tissue box size, i.e. approximately 4.43 inches×4.36 inches×5.06 inches.

FIGS. 6 and 7 show a use of a trash receptacle 600 according to another embodiment. A standard tissue box 2 is placed atop the attachable trash receptacle 600. The tissue box 2 is upheld above the receptacle 630 by a ridge 640 on the interior surface 601 of the attachable trash receptacle 600. Because the attachable trash receptacle 600 can be configured to rest conveniently below the tissue box 2, the combination of the attachable trash receptacle 600 and the tissue box 2 inhabits a relatively low area of resting surface such as a tabletop, countertop, ridge, etc., allowing free space to be maintained on the resting surface. As shown in FIG. 6, the attachable trash receptacle 600 can be configured to support a standard size tissue box 2 or a box with any other dimensions as may be suitable for any particular purpose. In FIG. 6, the tissue box is of a standard “rectangular” tissue box size, i.e. approximately 11.44 inches×4.38 inches×2.79 inches.

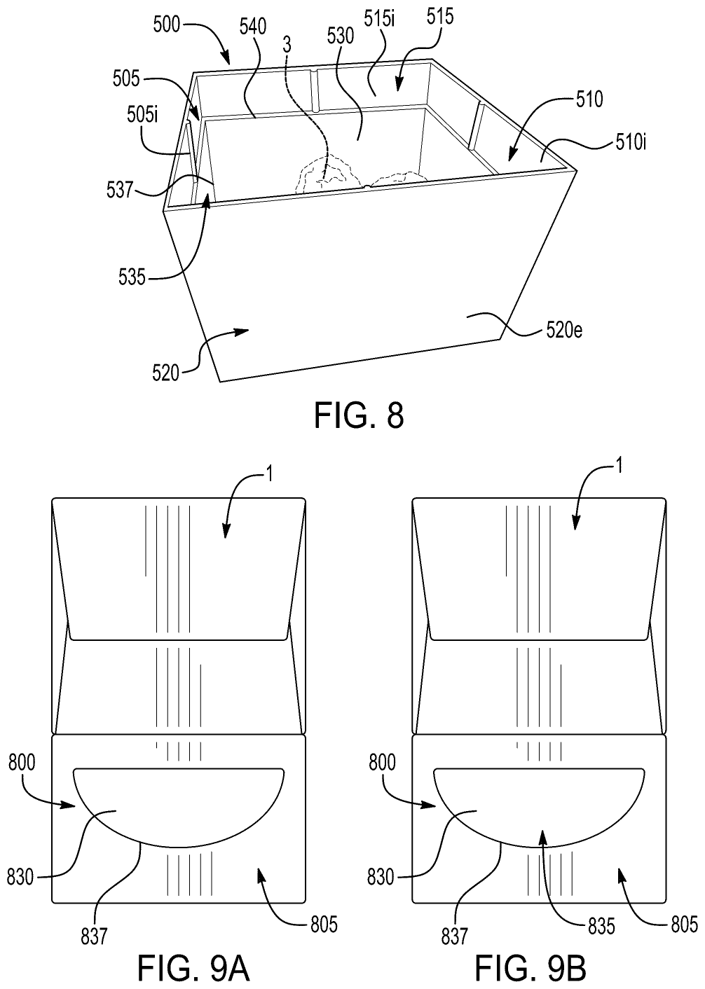

Turning next to FIG. 8, trash receptacle 500 is shown with tissues disposed of within the receptacle 530 of the attachable trash receptacle. Tissues 3 can be contained within the receptacle 530, for example, after tissues 3 have been deposited through the depositing opening 535 or through an opening on the top of the attachable trash receptacle 500. The attachable trash receptacle 500 may have tissues within the receptacle 530 without being in a position supporting a tissue box 1, such as for example, after the tissue box 1 has been removed from the attachable trash receptacle 500 prior to disposal of the contents of the attachable trash receptacle 500 and/or after the tissue box 1 has been emptied of tissues 3 and the tissue box 1 has been disposed of.

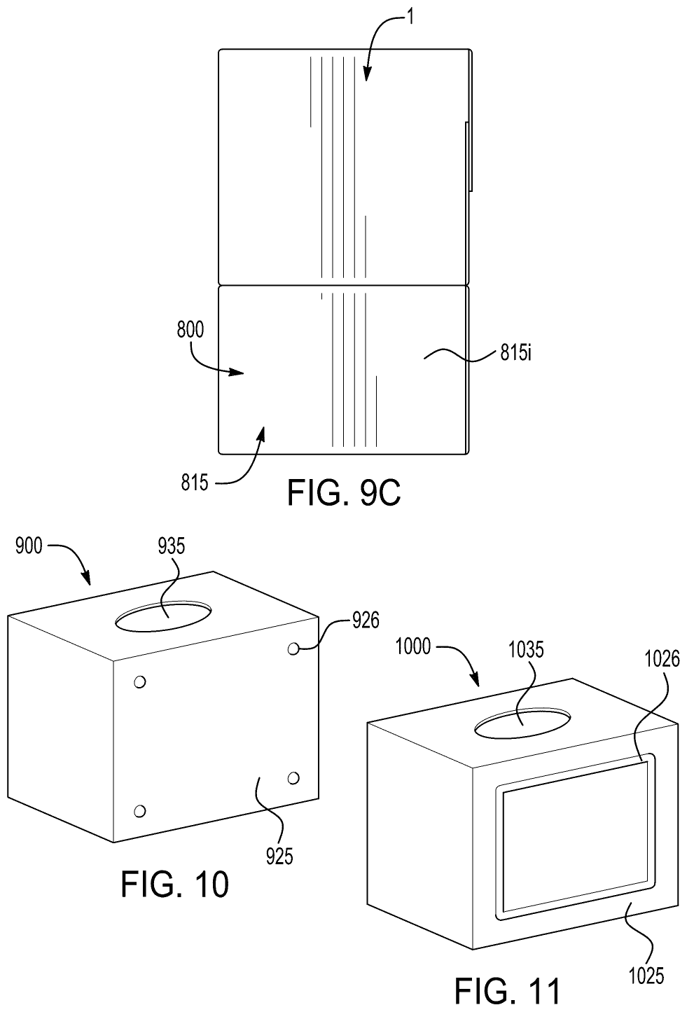

Turning next to FIGS. 9A-9C, an attachable trash receptacle 800 is shown. A tissue box 1 is placed atop the attachable trash receptacle 800. The tissue box 1 is upheld above the receptacle portion 830 of the attachable trash receptacle 800. As shown in the attachable trash receptacle 800, the disposal passageway 835 is not completely surrounded by the edge 837 of the depositing wall 805. Instead, the edge 837 of the disposal passageway 835 forms a “U” shape, with the edge 837 of the being non-contiguous, leaving an opening at the top of the depositing wall 805. The disposal passageway 835 can be of any suitable size or shape and can be completely surrounded by the edge 837 or be partially surrounded by the edge 837.

FIG. 10 depicts another trash receptacle 900. The trash receptacle 900 includes bottom side 925, having traction features 925 in the form of rubber stoppers. The traction features 925 can prevent the trash receptacle 900 from sliding or otherwise moving out of a chosen position on a tabletop, countertop, or shelf while the user is depositing tissues into the depositing opening 935, for example. Alternatively or additionally, the traction features 925 may include rubber materials, ridges, or any other suitable traction feature or friction-enhancing material. For example, in FIG. 11, attachable tissue box receptacle 1000 includes a bottom side 1025 having a traction feature 1026 in the form of rubber strips which can prevent movement of the trash receptacle 100 while trash is being deposited into the depositing opening 1035.

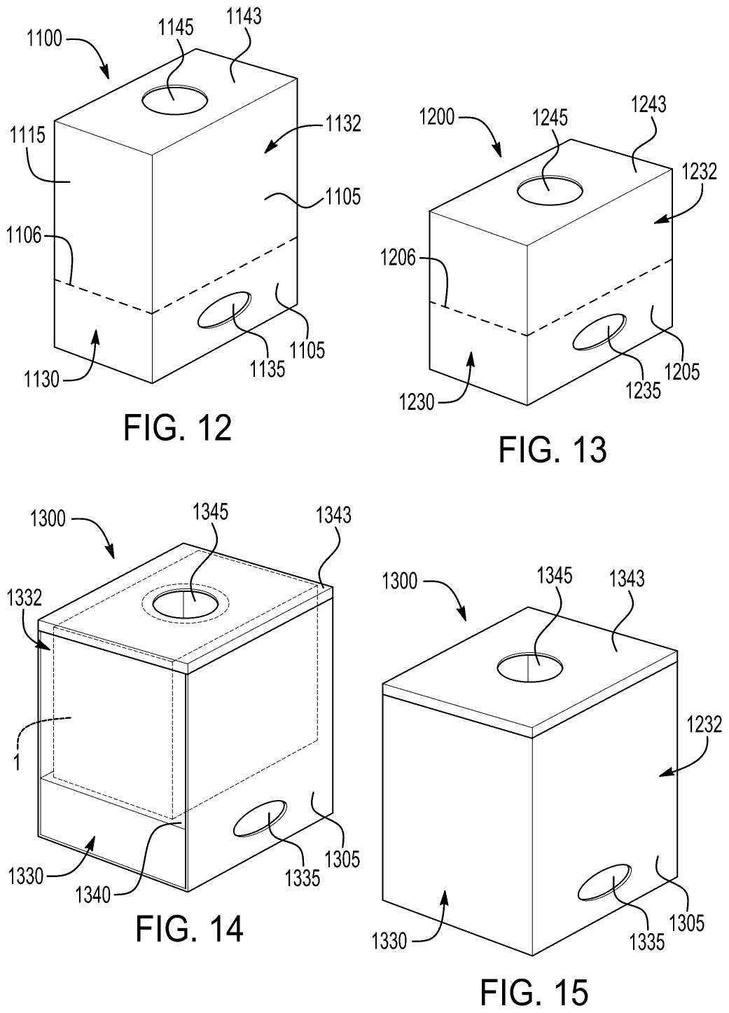

FIG. 12 depicts another attachable trash receptacle 1100. The trash receptacle 1100 generally includes the features of the above-described trash receptacles 1100, and further includes both a receptacle portion 1130 and a housing portion 1132 for a tissue box and/or tissues. The housing portion 1132 includes a top face 1143 defining a dispensing opening 1145. The dispensing opening 1145 can be configured to partially or completely align with the opening of a tissue box for ease of use of the dispensing opening 1145. The receptacle portion 1130 includes depositing opening 1135 defined by the depositing face 1105. Alternatively or additionally, the housing portion 1132 can hold paper towels, napkins, or other dispensable items. The housing portion 1132 and the receptacle portions 1130 can be movably connected at a connection region 1106 such that the housing portion 1132 and the receptacle portions 1130 can be separated. For example, the housing portion 1132 can rest upon a feature on the receptacle portion 1130, a side of the housing portion 1132 and a side of the receptacle portion 1130 can be connected via a hinge, or the housing portion 1132 and receptacle portion 1130 can be a unitary piece with a removable bottom face. This removable attachment of the receptacle portion 1130 and housing portion 1132 can allow new tissues or tissue boxes to be inserted into the housing portion 1132 and allow for trash to be emptied from the receptacle portion 1130.

FIG. 13 depicts another attachable trash receptacle 1200 including a receptacle portion 1230 and a housing portion 1232. The housing portion 1232 includes a top face 1245 defining a dispensing opening 1245. The receptacle portion includes a depositing face 1205 defining a depositing opening 1235. The housing portion 1232 and the receptacle portion 1230 are at least partially removably or adjustably connected at the connection region 1206.

FIGS. 14 and 15 depict another attachable trash receptacle 1300. The unit 1300 includes a housing portion 1332 including a top face in the form of a detachable lid 1243 to allow the user both to dispose of tissues and to refill the trash receptacle 1300 with a tissue box 1 and/or tissues, paper towels, or other dispensable products. The detachable lid 1243 defines a dispensing opening 1345 which allows a user to remove tissues from within the housing portion 1332 while the detachable lid 1243 is secured or rested upon the remaining walls of the housing portion 1330. The housing portion 1332 and the receptacle portion 1330 can be one unitary piece. Alternatively or additionally, the receptacle portion 1330 and the housing portion may be connected in such a manner that they are flush with each other along their external surfaces while the trash receptacle 1300 is in an assembled state in which the detachable lid 1343 is connected to the housing portion 1332. As shown, the tissue box 1 can rest upon a ridge 1340 located within the receiving portion 1330.

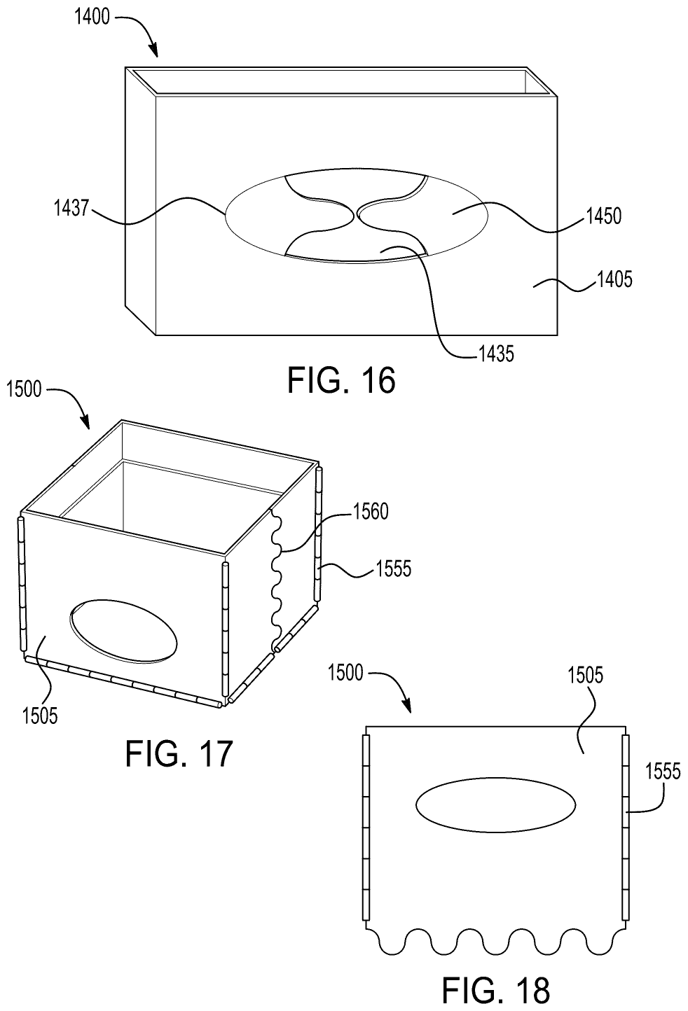

FIG. 16 depicts another embodiment of an attachable trash receptacle 1400 which includes flaps 1450 connected to the edge 1437 of the depositing opening 1435. The flaps are flexible to permit depositing of the used tissues or other trash through the depositing opening into the receptacle portion. The flaps 1450 beneficially hide disposed objects from external view of the depositing opening 1405, enhancing the appearance of the trash receptacle 1400 while trash is within the trash receptacle 1400. Furthermore, the flaps 1450 can also prevent trash from undesirably falling out of the trash receptacle 1400 in the event that the trash receptacle 1400 is transported or used in a moving vehicle, for example. The flaps 1450 can be made of rubber, plastic, fabric, composite, paper, or any other suitable material. Alternatively or additionally, the flaps 1450 may be made of a recyclable and/or biodegradable material. The flaps 1450 may be permanently fixed to the trash receptacle 1400, be one contiguous piece with the trash receptacle 1400, or be removably connected to the trash receptacle 1400. The flaps 1450 may be connected to the receptacle 1400 using any suitable method such as snaps, hook-and-loop closures, or bolts.

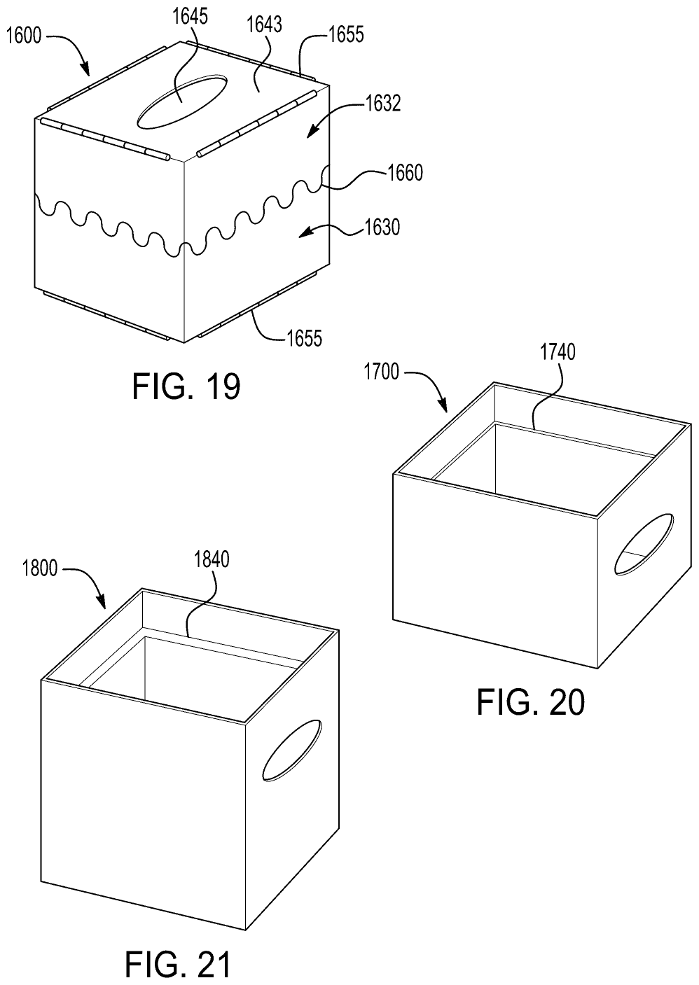

FIGS. 17 and 18 depict another embodiment of an attachable trash receptacle 1500. The trash receptacle 1500 is collapsible to allow for ease of storage while not in use. The trash receptacle 1500 can include hinges 1555 between the faces and buckling points 1560 or folding points allowing the faces to be folded along chosen axes. For example,

FIG. 19 depicts another embodiment of an attachable trash receptacle 1600. The trash receptacle 1600 includes a dispensing face 1643 defining a dispensing opening 1645. The trash receptacle 1600 includes hinges 1655 and buckling points 1660. The hinges 1655 can surround the dispensing face 1643 to allow the rest of the trash receptacle 1600 to fold or collapse behind or around the dispensing face 1643.

FIG. 20 depicts another embodiment of an attachable trash receptacle 1700. The trash receptacle 1700 includes a ridge 1740 having a width sufficient to allow a tissue box to sit atop the ridge 1740. FIG. 21 depicts another embodiment of an attachable tissue box receptacle 1800, which includes a ridge having a wider width to accommodate a smaller tissue box.

As used herein, an “operative connection,” or a connection by which entities are “operatively connected,” is one in which the entities are connected in such a way that the entities may perform as intended. An operative connection may be a direct connection or an indirect connection in which an intermediate entity or entities cooperate or otherwise are part of the connection or are in between the operatively connected entities. An operative connection or coupling may include the entities being integral and unitary with each other.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated embodiment or embodiments of the invention. In addition, while a particular ridge of the invention may have been described above with respect to only one or more of several illustrated embodiments, such ridge may be combined with one or more other ridges of the other embodiments, as may be desired for any given or particular application.

What is claimed is:

1. An attachable trash receptacle for supporting a container comprising:
a depositing wall connected to one or more additional walls;
wherein the depositing wall and the one or more additional walls have interior surfaces and exterior surfaces;
wherein the interior surfaces define a receptacle for receiving an object;
wherein the depositing wall comprises an edge defining a depositing opening contiguous with the receptacle; and
wherein the interior surfaces comprise a ridge configured to support at least a portion of the container.

2. The attachable trash receptacle of claim 1, wherein the container is a tissue box.

3. The attachable trash receptacle of claim 2, wherein the tissue box is of a standard size and shape.

4. The attachable trash receptacle of claim 1, wherein the attachable trash receptacle comprises one or more of cardboard or plastic.

5. The attachable trash receptacle of claim 1, wherein the attachable trash receptacle is at least partially additively manufactured or 3D-printed.

6. The attachable trash receptacle of claim 1, wherein the attachable trash receptacle is unitary with the container.

7. The attachable trash receptacle of claim 1, wherein the depositing opening is completely surrounded by the edge.

8. The attachable trash receptacle of claim 1, wherein the depositing opening is partially surrounded by the edge.

9. The attachable trash receptacle of claim 1, wherein the container is of a standard size and shape.

10. The attachable trash receptacle of claim 1, further comprising hinges configured to collapse the attachable trash receptacle into a flattened state.

11. The attachable trash receptacle of claim 1, wherein at least one or more of the dispensing wall or the depositing wall are foldable.

12. The attachable trash receptacle of claim 1, further comprising a bottom wall connected to the depositing wall and the additional side walls.

13. The attachable trash receptacle of claim 14, wherein the bottom wall comprises traction features on a bottom wall outer side.

14. A tissue box receptacle unit comprising:
a depositing wall connected to one or more additional walls; and
a dispensing wall configured to be connected to the one or more additional walls;
wherein the depositing wall, the dispensing wall, and the one or more additional walls have interior surfaces and exterior surfaces;
wherein the interior surfaces define a receptacle for receiving an object and a dispensing chamber for dispensing the object;
wherein the depositing wall comprises a depositing edge defining a depositing opening contiguous with the receptacle;
wherein the interior surfaces comprise a ridge configured to support a container; and
wherein the dispensing wall comprises a dispensing edge defining a dispensing opening contiguous with the dispensing chamber.

15. The tissue box receptacle unit according to claim 14, further comprising flexible flaps connected to the edge of the depositing opening.

16. The tissue box receptacle unit according to claim 14, further comprising one or more hinges configured to collapse the tissue box receptacle unit into a flattened state.

17. The tissue box receptacle unit according to claim 14, wherein at least one of the depositing wall, the additional walls, or the dispensing wall are foldable.

18. The tissue box receptacle unit according to claim 14, wherein the dispensing wall is removably attached to the additional side walls and the depositing wall.

19. The tissue box receptacle unit according to claim 14, further comprising a bottom wall connected to the depositing wall and the one or more additional side walls.

20. The tissue box receptacle unit according to claim 14, wherein the bottom wall comprises a traction feature on a bottom wall bottom side.
